(19) United States
(12) Patent Application Publication
(10) Pub. No.: US 2016/0108970 A1
(43) Pub. Date: Apr. 21, 2016

(54) Articulated Drive Shaft

(71) Applicant: KLX ENERGY SERVICES LLC, Houston, TX (US)

(72) Inventor: Toby Scott Baudoin, Rayne, LA (US)

(21) Appl. No.: 14/919,330

(22) Filed: Oct. 21, 2015

Related U.S. Application Data
(60) Provisional application No. 62/066,607, filed on Oct. 21, 2014.

(51) Int. Cl. F16D 3/221; E21B 17/20

(52) U.S. Cl. CPC F16D 3/221; E21B 17/20

(57) ABSTRACT

An articulated drive shaft for a downhole mud motor is provided for transmission of torque and thrust loads from one member to another mainly comprising a driven member, ball members, a plurality of rollers, ball socket members and cylindrical driver members. The drive shaft is allowed to transmit torque and thrust loads through a given angular range between the axes of members on each end of the assembly. Several sealing means for retaining lubricants within the joints are provided while maintaining the mud motor's ability to articulate within borehole. A flow diverter may also be incorporated into the drive shaft to provide a means for fluid passage through the chive shaft.

### PRIORITY

This application claims priority to U.S. provisional application Serial No. 62/066,607 filed Oct. 21, 2014 entitled “Articulated Drive Shaft and Method”, the entire content of which is incorporated b reference.

### FIELD OF THE INVENTION

This invention pertains to downhole equipment for oil and gas wells. More particularly, it pertains to an articulated drive shaft for a downhole mud motor and, more particularly, this invention relates to an articulated drive shaft for transferring torque and thrust loads from the rotor to the mud motor mandrel.

### BACKGROUND OF THE INVENTION

In the drilling of directional wellbores, conventional drilling methods of rotating a drill hit on the lower end of a pipe suing are inadequate to create the curved portion the borehole. Thus, mud motors which include a bent section generally up to 3 degrees, are utilized to drill this curved portion.

These mud motors consist of three major components a power section consisting of a rotor and a stator, a drive shaft, and a bearing assembly. The power section converts fluid pressure from the drilling fluid being, pumped into rotational energy. The rotor is a helically fluted shaft that rotates eccentrically within the stator. The drive shaft must transfer the eccentric rotation and torque from the rotor to a concentric rotation and torque to the bearing assembly. It MUM also transfer the thrust load from the rotor to the bearing assembly. The bend plane of the mud motor generally lies within the drive shaft housing. Thus, the drive shaft must also accommodate this bend. For these reasons, the drive shaft must be sufficiently robust to withstand the tremendous torque of the power section while having the ability to articulate in order to accommodate the eccentric rotation of the rotor and the bend in the dine shaft housing.

The drive shafts of mud motors currently utilized are limited in the amount of torque which can be outputted, in many cases being unable to apply sufficient strength to transmit the torque required to advance a wellbore. In such event, drilling operations must be slowed or even halted in order to properly position the mud motor before further advancement. Such processes are time consuming and incur additional cost in man hours. As well, pushing traditional mud motors to their maximum torque capacity causes considerable stress on its moveable components and requires input of excessive amounts of fluid through the components and seals of the mud motor. Operating mud motors at such high stress makes them subject to regular breakdown due to excessive wear and tear on the motor components and, in particular, the motor pressure seals which are vital for maintaining fluid pressure.

Consequently, there is a need for a mud motor having an articulated drive shaft capable of withstanding the high level of torque required by the associated power sections without the motor being susceptible to the negative effects of those torque requirements, or from the external pressures, debris, and other precarious factors associated with a mud motor operating in a wellbore drilling environment.

### SUMMARY OF THE INVENTION

The present invention provides an articulated drive shaft for a mud motor that satisfies the aforementioned needs. The articulated drive shaft assembly is configured to be safely retained within a housing and is generally comprised of an upper member known as a “driver” which forms a means for threadedly connecting, to the rotor of a mud motor, a ball member containing a plurality of pockets to suit torque transmitting elements such as rollers, a ball socket with a plurality of pockets or slots suited for receiving the ball and rollers, and a central elongated member known as a “driven”. Typically the articulated drive shaft assembly is configured to have the driven positioned between an upper driver and a lower driver with corresponding balls and ball sockets, thus forming two articulating “joints”.

The driver is a cylindrical member with a threaded connection on each end. One threaded connection is external for connection to a rotor or to a flow diverter. The other, an internal threaded connection, is for connection to the ball member. The driver transfers torque from the rotor to the ball member on the upper end or from a ball to a flow diverter on the lower end. It also transfers thrust loads from the rotor to other components of the drive shaft assembly.

The ball member is an elongated member with a spherical profile on one end and elongated threaded surface on the other. A plurality of pockets or slots is provided on the spherical portion to accommodate a plurality of corresponding torque transmitting elements. The torque transmitting elements, called rollers, may be provided in any number of geometric shapes and or sizes. The rollers may range in shape from balls to square keys. The function of the ball and rollers is to transfer torque and thrust loads from the driver to the ball socket or vice versa.

The ball socket is a cylindrical member for providing sliding retention of the ball member within. The ball socket contains a plurality of pockets or elongated slots within its interior bore to accommodate the rollers. The ball socket transfers torque from the ball and rollers to the driven member or vice versa. The ball socket is configured to articulate to a desired given angle with relation to the ball in order to accommodate the eccentricity of the rotor as well as the bend angle of the mud motor (drive shaft housing). The combination of the ball and ball socket having the ability to articulate is known as a “joint”.

The driven is an elongated member with threads on each end for attachment to the ball socket. The function of the driven is to connect the joints created by the ball member and ball socket on each end of the driven and thus enable transmitting torque and thrust loads from one joint to the other.

The drive shaft assembly may also include other components such as ball seats and/or face sealing rings. The ball seat may be manufactured as a separate component since it is considered as a consumable and inexpensive to replace upon servicing or may be incorporated into the opposing ends of the driven. The face sealing ring is an additional component which may be utilized between the driven and the ball member to aid in the sealing of the joint. These face sealing rings may be spring, loaded to provide a known and constant force upon mating parts of the sealing rings and the spherical end of the ball member to aid in preventing, lubricants from escaping the joint and from allowing drilling fluids to enter the joint. These face seals may rely on metal to metal contact for sealing or may include a form of elastomer seal for sealing.

In some embodiments of the drive shaft assembly a flow diverter is provided in lieu a lower driver. The flow diverter is a tubular member positioned between the drive shaft and the mandrel of a bearing assembly. The flow diverter has holes connecting its outer surface to its central bore thereby allowing fluid travelling in the annulus between the interior of the drive shaft housing and exterior surface of the drive shaft into the central bore of the bearing assembly mandrel. Thus the flow diverter “diverts” fluid to the central bore of the bearing assembly so that the fluid can exit the mud motor through the drilling bit.

These and other objects, advantages, and features of this invention will be apparent to those skilled in the art from a consideration of this specification, including the claims and drawings herein.

### BRIEF DESCRIPTION OF DRAWINGS

FIG. 1 is an external side view of the articulated drive shaft apparatus.

FIG. 2 is a longitudinal cross-section view of the articulated drive shaft apparatus as shown in FIG. 1.

FIG. 3 is a close up view of one end of the articulated drive shaft apparatus as shown in FIG. 2.

FIG. 4 is a longitudinal partial cross-section view of the articulated drive shaft apparatus ball socket.

FIG. 5 is a longitudinal side view of the articulated drive shaft apparatus ball member.

FIG. 6 is a longitudinal cross-section view of a second embodiment of the articulated drive shaft apparatus.

FIG. 7 is a first embodiment of the articulated drive shaft torque transmission element.

FIG. 8 is a second embodiment of the articulated drive shaft torque transmission element.

FIG. 9 is a third embodiment of the articulated drive shaft torque transmission element.

FIG. 10 is a fourth embodiment of the articulated drive shaft torque transmission element.

FIG. 11 is a fifth embodiment of the articulated drive shaft torque transmission element.

FIG. 12 is a longitudinal cross-section view of as third embodiment of articulated drive shaft apparatus.

FIG. 13 is a longitudinal cross-section view of a fourth embodiment of articulated drive shaft apparatus.

FIG. 14 is a longitudinal cross-section view of a fifth embodiment of articulated drive shaft apparatus with an attached flow diverter attached.

FIG. 15 is a detail view of the portion P of the fourth embodiment of articulated drive shaft apparatus shown in FIG. 16.

FIG. 16 is a longitudinal cross-section view of the fifth embodiment of articulated drive shaft apparatus of FIG. 14 showing the location of detail view P shown in FIG. 15.

### DESCRIPTION OF THE EMBODIMENTS

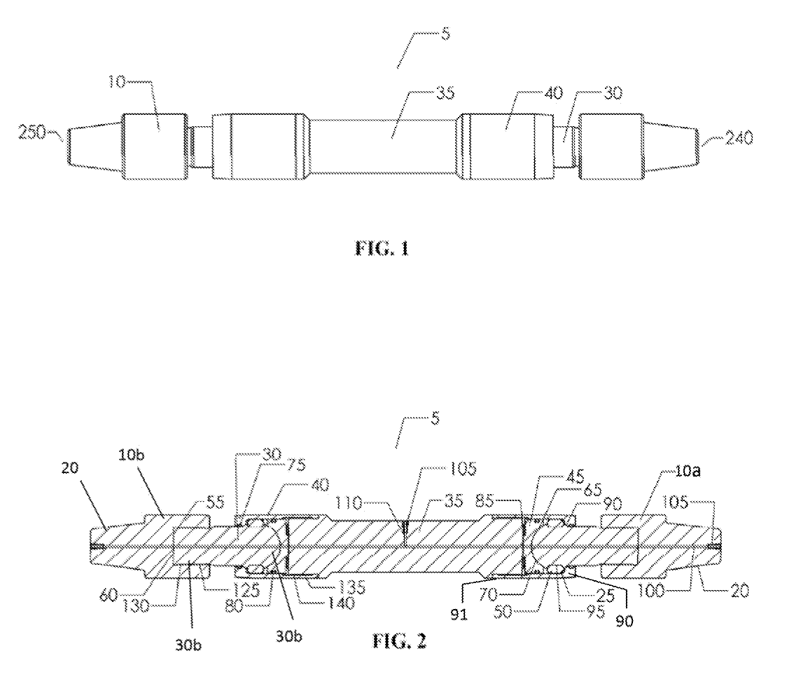

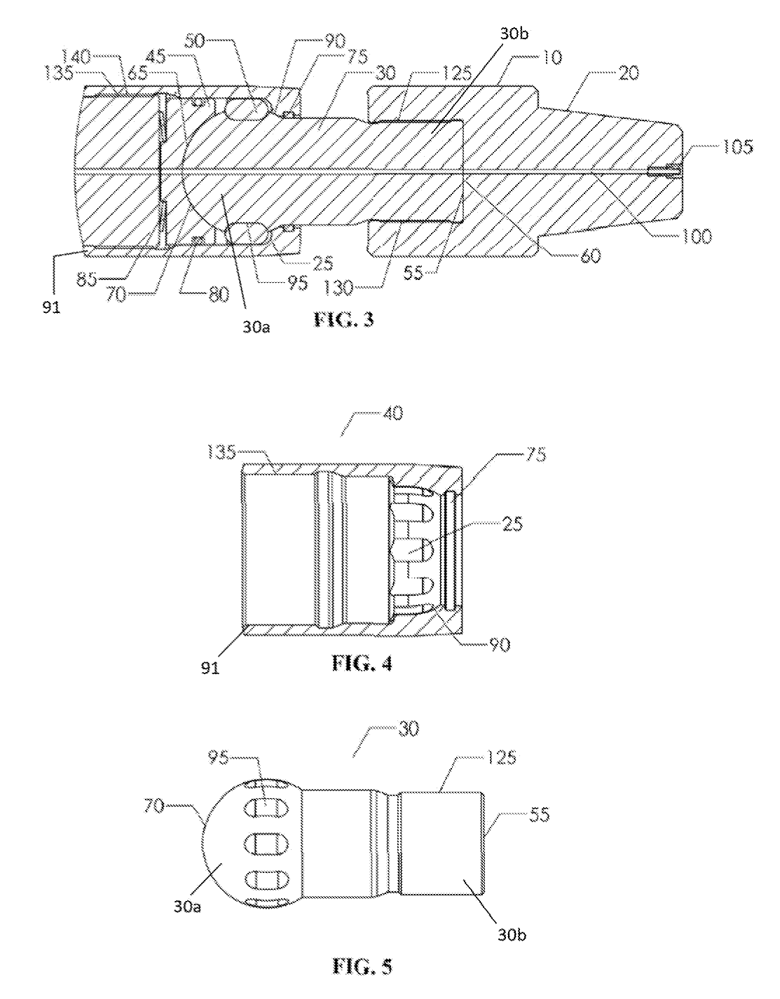

FIGS. 1 and 2 show a first embodiment of an articulated drive shaft (5). The articulated drive shaft (5) has a central elongated member known as a “driven” (35) positioned between upper and lower cylindrical members, each known as a “driver” (10a & 10b). This combination provides an upper cylindrical driver (10a) at upper end (240) of the drive shaft (5) and a lower cylindrical driver (10b) at lower end (250) of the drive shaft (5). Driver (10a) at upper end (240) of drive shaft (5) is threadedly attached to a rotor of a mud motor or other rotational device by means of threaded connection (20). Driver (10b) at lower end (250) of drive shaft (5) is threadedly attached to a pipe sub or to a drill bit by means of threaded connection (20).

Cylindrical drivers (10a & 10b) at the upper end (240) and lower end (250) each have a ball member (30) having a spherical end (30a) and an elongated shaft (30b). Elongated shall (30b) has external attachment threads (125) which allow for threaded attachment to cylindrical drivers (10a & 10b) by means of a threaded connection between internal threaded connections (130) on each cylindrical driver (10a & 10b) and hall shaft attachment threads (125) so that the face (55) of the threaded shaft of the ball member (30) seals against face (60) of driver (10).

The spherical end (30a) of each ball member (30) is inserted through a corresponding ball socket (40). Ball sockets (40) are cylindrical with a ball containing end (90) as to contain the rounded nature of spherical end (30a) of ball member (30) and a threaded end (91) with internal threaded connection surfaces (135) for threaded connection to the externally threaded connection surfaces (140) of driven (35). An internal sealing ring (45) is provided between the each spherical end (30a) of ball members (30) and upper (240) and lower ends (250) of driven (35).

Each internal sealing ring (45) has a concave internal face (65) that conforms to the convex face (70) on the spherical end (30a) of each ball member (30). The face (70) of the ball member (30) seals against the internal face (65) of sealing ring (45) when drive shaft (5) is held in compression by the rotor. Face (70) of ball member (30) complements internal face (65) of sealing ring (45) such that the two faces will form a seal even upon articulation of the joint. This seal aids in preventing lubricants (not pictured) from escaping the joint as well as preventing. drilling fluids from entering the joint. Each sealing ring (45) may also be spring loaded by means of spring (85) to provide a known and constant force upon face (70) of bail member (30) and face (65) of internal face sealing ring (45). Sealing rings or gaskets (80) may also be provided to aid in creating a seal between each sealing ring (45) and each ball socket (40).

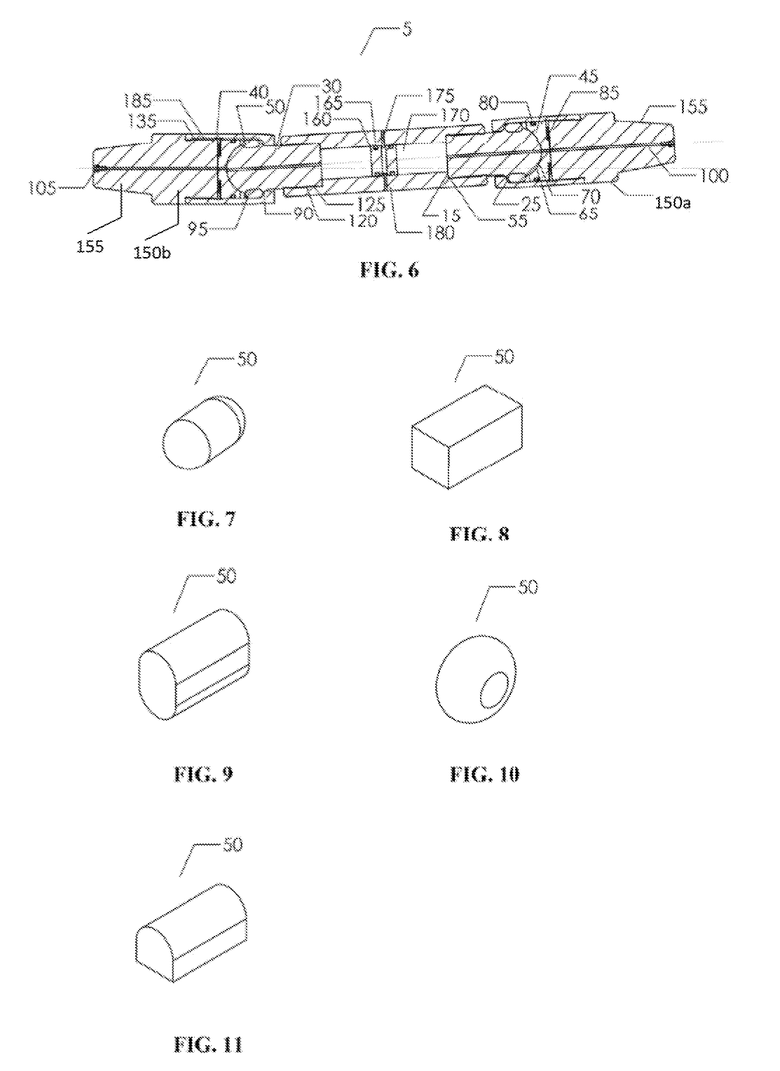

The spherical end (30a) of each ball member (30) is provided with a plurality of pockets (95) to correspond with a plurality of torque transmitting elements, or rollers (50) As sheen by FIGS. 7, 8, 9, 10, and 11, the rollers (50) may be provided in a variety of desired shapes and/or sizes. FIG. 7 depicts rollers (50) as being of an ovoid shape. FIG. 8 depicts rollers (50) as being of a cube or brick shape. FIG. 9 depicts rollers (50) as being of a cylindrical shape. FIG. 10 depicts rollers (50) as being of a spherical shape. FIG. 11 depicts rollers (50) as being of a semi-cylindrical shape.

Each of the ball sockets (40) are provided with a plurality of pockets (25) that correspond with the pockets (95) and rollers (50) at the spherical end (30a) of ball member (30). The rollers (50) serve as torque transmission elements to transfer torque from the ball member (30) to the ball socket (40) by means of pockets (95) on the ball member (30) and pockets (25) of the ball socket (40).

Grease fittings (105) are inserted into each driver (10) and also the driven (35) so that lubrication of the drive shaft (5) may be provided. Lubricants (not pictured) from the grease fittings (105) are disbursed throughout the draft shaft assembly through lubrication passages (100) and (110).

Each ball socket (40) has a given angle in which it can articulate in relation to each ball member (30). This articulation of the ball socket (40) accommodates the eccentricity of the rotor as well as the bend angle of the mud motor (drive shaft housing). Each ball socket (40) utilizes a sealing element (75) to form a seal between the ball socket (40) and the corresponding ball member (30). Because each ball socket (40) is threadedly connected to the driven (35), torque may be transferred from the upper end (240) to the lower end (250) of the drive shaft assembly (5).

The rollers (50) are shown as separate components but the rollers (50) may be machined directly onto bail member (30). Doing so would eliminate the need for the rollers (50) altogether, as the ball member (30) would include protrusions that would serve to transfer torque for the member (30) to the ball socket (40) in lieu of the individual rollers (50).

A second embodiment of the articulated drive shaft (5) is shown in FIG. 6. As shown in FIG. 6, the articulated drive shaft (5) has a compensating driven member (180) having a central bore (170) for holding lubricants (not pictured) and opposing driven pistons (160). Drilling fluids surrounding the drive shaft (5) will enter holes (175) in pressure compensating driven (180) and the pressure from the entering drilling fluids will force pistons (160) to move outwardly, which will then force the lubricants (not pictured) through lubrication passages (100) and lubricate the joints. The fluid pressure on pistons (160) will maintain positive pressure upon the lubricant, making certain the joint remains full of lubricant (not pictured). Pistons (160) utilize a piston sealing element (165) to create a seal between piston (160) and the central bore of driven (180). This piston sealing element (165) prevents lubricants (not pictured) from escaping the bore (170) and also prevents drilling fluid from entering the bore (170).

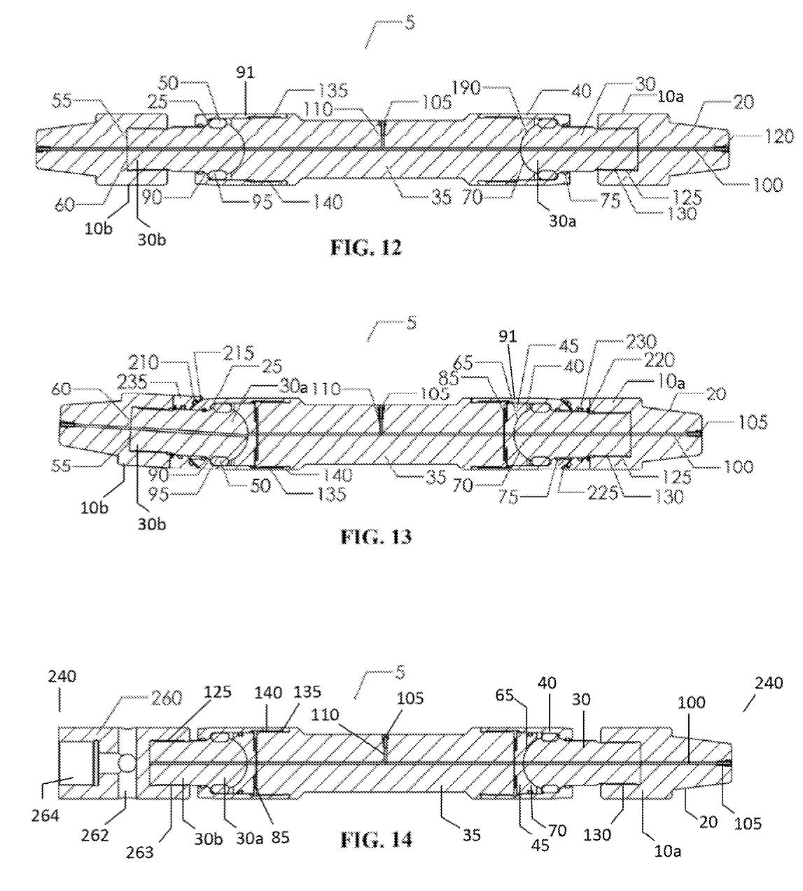

A third embodiment of the articulated drive shaft (5) is shown in FIG. 12. The third embodiment illustrated in FIG. 12 is similar to the embodiment shown in FIGS. 1 and 2 with the exception that in FIGS. 1 and 2, face (65) of internal sealing ring (45) lays between the driven member (35) and each bail member (30) where face (70) of the spherical end (30a) of ball member (30) it in sealed communication with face (65) of internal sealing ring (45). In the third embodiment depicted in FIG. 12, face (70) of ball member (30) seals directly on the concave face (190) of driven (35); rather than using a spring-loaded face sealing ring (45). Face (190) of driven (35) complements face (70) of ball member (30) so that the two faces will form as seal even upon articulation of the joint.

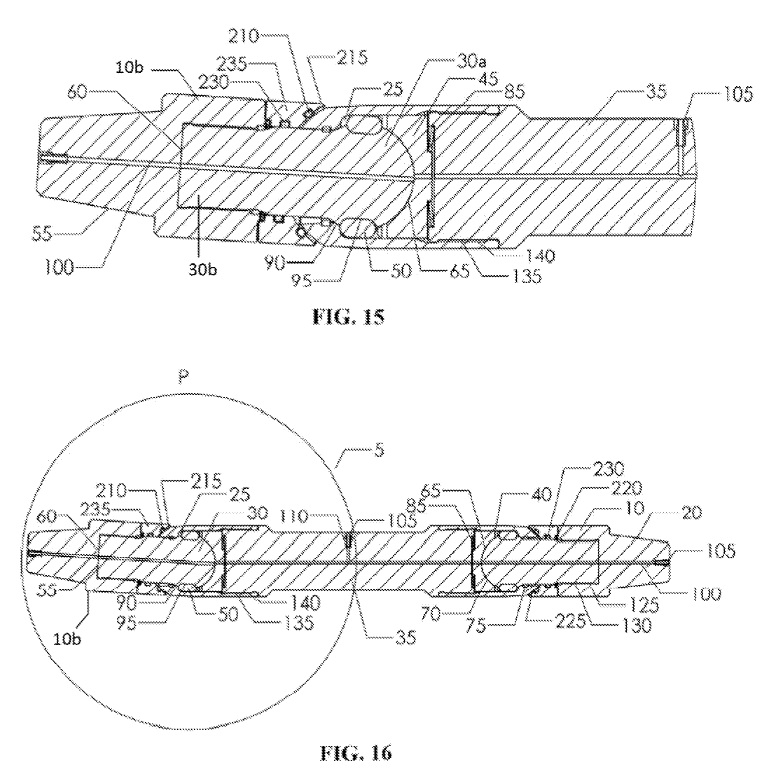

A fourth embodiment of articulated drive shaft (5) of the articulated drive shaft (5) is shown in FIG. 13 and in more detail in FIGS. 15 and 16. This fourth embodiment contains an additional component, namely an external face sealing ring (235) that provides an additional sealing element to contain lubricant within the joint. More specifically, spring (85) forces face (65) of the internal sealing ring (45) to seal on face (70) of each ball member (30) and spring (220) forces curved face (225) of external face sealing ring (235) to seal on curved face (215) of the ball containing end (90) of ball socket (40). Springs (85) and (220) may be of any form including but not limited to coil springs, wire form springs, disc springs, polyurethane springs, or wave springs and may be of any material.

Sealing element (75) located on ball socket (40) creates a seal between ball socket (40) and ball member (30). This seal prevents lubrication from escaping the joint and also prevents drilling fluid from entering the joint. This seal will aid in the prevention of drilling fluids from entering the joint Sealing ring or gasket (210) creates a seal between external face sealing ring (235) and bail socket (40). This seal provides another means of preventing drilling fluid from entering the joint. Sealing element (230) creates a seal between face sealing ring (235) and ball member (30), preventing drilling fluid from entering the joint.

FIG. 14 shows a fifth embodiment of the articulated drive shaft (5). In this fifth embodiment, in lieu of a lower driver (10b) a flow diverter (260) having internal attachment threads (263) is threadedly attached to the external attachment threads (125) on the elongated shaft (30b) of hall member (30) at the lower end (250) of the articulated drive shaft (5). Flow diverter (260) has radially extending holes or fluid ports (262) extending to outer surface of the flow diverter that are in communication with its central bore (264) which allow fluid to be diverted from the exterior of drive shaft (5) to the central bore of the bearing assembly so that fluid can exit the mud motor through a drilling bit.

I claim:

1. An articulated drive shaft for transferring torque and thrust loads comprising:
a. a central elongate driven member, said driven member having an upper and lower end, wherein said upper and lower ends of said driven member have external threaded attachment surfaces;
b. ball sockets having an internally threaded end threadedly attached to said external threaded attachment surfaces of said upper and lower ends of said driven member and a ball containing end;
c. a ball member slidably contained within each said ball socket, said ball members having a spherical end and an elongate shaft end, wherein said elongate shaft end of said ball member extends outside of said ball containing end of said ball socket, wherein said elongate shaft end of said ball member has an external threaded attachment surface;
d. an upper cylindrical driver member threadedly attached to said external threaded attachment surface of said elongate shaft of said ball member within said ball socket threadedly attached to said upper end of said driven member;
e. a plurality of pockets arranged around the internal, periphery of each said ball socket between said ball members and said ball socket; and
f. a plurality of rollers arranged in sliding communication within said pockets between said ball sockets and said ball members, herein said rollers correspond to said pockets for transmission of torque.

2. The articulated drive shaft of claim 1 wherein said rollers are ovoid, cylindrical, spherical, or semi-cylindrical in shape.

3. The articulated drive shaft of claim 1 wherein said rollers are fixedly attached as protrusions arranged around the outer periphery of each said ball member.

4. The articulated drive shaft of claim 1 further comprising:
a. lubrication passages which traverse each said upper cylindrical driver member, each said ball members, and said driven member; and
b. grease fittings incorporated into each said lubrication passages said upper cylindrical driver and said driven member for lubrication of said lubrication passages.

5. The articulated drive shaft of claim 2 wherein said upper cylindrical driver member has an external threaded attachment surface.

6. The articulated drive shaft of claim 3 further comprising:
a. internal sealing rings contained within said ball socket between said upper and lower ends of said driven member and said ball members, said sealing ring having a concave face, wherein said spherical end of said ball member is in sliding communication within said concave face of said sealing ring in said ball socket;
b. a sealing gasket upon said internal sealing ring, wherein said sealing gasket is in sealed communication with said ball socket;
c. a sealing element upon said ball socket, wherein said sealing element is in sealed communication with said ball member;
d. at least one spring upon said sealing ring between said sealing ring and said driven, wherein said spring provides a constant force upon said sealing ring to engage said concave face upon said spherical end of said ball member, wherein the constant force of said spring creates a seal between said sealing gasket of said sealing ring and said ball socket, said concave face of said sealing ring and said spherical end of said ball member, and said sealing element and said ball socket; and
e. a flow diverter threadedly attached to said external threaded attachment surface of said elongate shaft of said ball member contained within said ball socket threadedly attached to said lower end of said driven member, said flow diverter having at least one fluid port extending through said flow diverter.

7. The articulated drive shaft of claim 6 wherein said rollers are fixedly attached as protrusions arranged around the outer periphery of each said ball member.

8. The articulated drive shaft of claim 3 further comprising a lower cylindrical driver threadedly attached to said threaded attachment surface of said elongate shaft of said ball member within said ball socket threadedly attached to said lower end of said driven member, said lower cylindrical driver member having an external threaded attachment surface, wherein said lubrication passages further traverse said lower cylindrical driver member, said lubrication passage traversing said lower cylindrical driver further comprising a grease fitting for lubrication of said lubrication passages.

9. The articulated drive shaft of claim 8 wherein said upper and lower ends of said driven member have a concave face, wherein said spherical end of said ball member is in sliding communication upon said concave faces of said upper and lower ends of said driven member.

10. The articulated drive shaft of claim 9 wherein said rollers are fixedly attached as protrusions arranged around the outer periphery of each said bail member.

11. The articulated drive shaft of claim 8 further comprising:
a. internal sealing rings contained within said ball socket between said upper and lower ends of said driven member and said ball members, said sealing ring having a concave face, wherein said spherical end of said ball member is in sliding communication within said concave face of said sealing ring in said ball socket;
b. a sealing gasket upon said internal sealing ring, wherein said sealing gasket is in sealed communication with said ball socket;
c. a sealing element upon said ball socket, wherein said sealing element is in sealed communication with said ball member; and
d. at least one spring upon said sealing ring between said sealing ring and said driven, wherein said spring provides a constant force upon said sealing ring to engage said concave face upon said spherical end of said ball member, wherein the constant force of said spring creates a seal between said sealing gasket of said sealing ring and said ball socket, said concave face of said sealing ring and said spherical end of said ball member, and said sealing element and said ball socket.

12. The articulated drive shaft of claim 11 wherein said rollers are fixedly attached as protrusions arranged around the outer periphery of each said ball member.

13. The articulated drive shaft of claim 11 further comprising:
a. a curved face upon said ball containing end of said ball sockets;
b. external sealing rings between each said upper and lower cylindrical drivers and said ball sockets, said face sealing rings surrounding said elongate shaft of said ball member in threaded communication with said upper and lower cylindrical drivers, wherein said face sealing rings have a curved face for sealed communication with said curved face of said bail containing end of said ball sockets;
c. a sealing gasket upon said external sealing ring, wherein said sealing gasket is in sealed communication with said el agate shaft end of said ball member;
d. a sealing element upon said external sealing ring, wherein said sealing element is in sealed communication with said ball socket; and
e. at least one spring between each said upper and lower cylindrical drivers and said external sealing ring, wherein said spring provides a constant force upon said external sealing ring to engage said curved face of said external sealing rings upon said curved face of said ball sockets, wherein the constant force of said spring creates a seal between said sealing gasket of said external sealing ring and said elongate shaft end of said ball member and between said sealing element and said ball socket.

14. The articulated drive shaft of claim 13 wherein said rollers are fixedly attached as protrusions arranged around the outer periphery of each said ball member.

15. An articulated drive shaft for transferring torque and thrust loads comprising:
a. a central elongate driven member, said driven member having an upper and lower end, said driven member having a central bore, said driven member having holes into said central bore for pressure compensation, wherein said upper and lower ends of said driven member have internal threaded attachment surfaces;
b. ball members having a spherical end and an elongate shaft end, said elongate shaft end of said ball member having an external threaded attachment surface threadably engaged with said internal threaded attachment surfaces of said upper and lower ends of said driven member, wherein said spherical ends of said ball members extend outward from said upper and lower ends of said driven member;
c. ball sockets having a ball containing end slidably surrounding containing each said spherical end of said ball members and an internally threaded end;
d. upper and lower cylindrical driver members having externally threaded surfaces threadedly attached to said internal threaded attachment surface of said ball sockets;
e. a plurality of pockets arranged around the internal periphery of each said ball socket between said ball members and said ball socket;
f. a plurality of rollers arranged in sliding communication within said pockets between said ball sockets and said ball members, wherein said rollers correspond to said pockets for transmission of torque;
g. internal sealing rings contained within each said ball socket between said upper and lower cylindrical drivers and said spherical ends of said ball members, said internal sealing ring having a concave face wherein said spherical end of said ball member is in sliding communication within said concave face of said internal sealing ring in said ball socket;
h. a sealing gasket upon said internal sealing ring, wherein said sealing gasket is in sealed communication with said bail socket;
i. at least one spring upon each said internal sealing ring between said internal sealing rings and said upper and lower cylindrical drivers, wherein said spring provides a constant force upon said sealing ring to engage said concave face upon said spherical end of said ball member, wherein the constant force of said spring creates a seal between said sealing gasket of said sealing ring and said ball socket and said concave face of said sealing ring and said spherical end of said ball member;
j. lubrication passages in fluid communication with said central bore, said lubrication passage traversing each said upper and lower cylindrical driver members, each said internal sealing rings, and each said ball members;
k. grease fittings incorporated into each said lubrication passages of each said upper and lower cylindrical drivers for lubrication of said lubrication passages;
l. opposing pistons within said central bore of said driven member, wherein said pistons are arranged upon either side of said holes of said driven member, said pistons being in fluid communication between said holes of said driven member and said lubrication passages, wherein said piston moves under fluid pressure entering said central bore through said holes to move lubricant through said lubrication passages; and
m. a piston sealing element upon said piston between said piston and said driven member.

16. The articulated drive shaft of claim 15 wherein said upper and lower cylindrical driver member have an external threaded attachment surface.

17. The articulated drive shaft of claim 16 wherein said rollers are fixedly attached as protrusions arranged around the outer periphery of each said ball member.
